(19) United States
(12) Patent Application Publication
(10) Pub. No.: US 2018/0352949 A1
(43) Pub. Date: Dec. 13, 2018

(54) Mount for Attaching Electronic Devices to a Guitar Stand

(71) Applicant: Reggie Wayne Newsome, Midlothian, VA (US)

(72) Inventor: Reggie Wayne Newsome, Midlothian, VA (US)

(21) Appl. No.: 15/983,087

(22) Filed: May 17, 2018

Related U.S. Application Data
(63) Continuation-in-part of application No. 15/435,107, filed on Feb. 16, 2017, now Pat. No. 10,039,375.
(60) Provisional application No. 62/507,614, filed on May 17, 2017.

(51) Int. Cl. A47B 19/00; F16M 13/02; F16M 11/20

(52) U.S. Cl. CPC A47B 19/002; F16M 11/10; F16M 11/2021; F16M 13/022

(57) ABSTRACT

A mount that is used to attach electronic devices to a guitar stand is made of a back panel, a clamping mechanism, a support scissor mechanism, and a stand-grasping fastener. The clamping mechanism is a user-actuated clamp that uses a fixed jaw and a movable jaw to hold electronic devices against the back panel. The back panel, which is a rigid plate, is connected to the fixed jaw to further support the clamped electronic device. Additionally, the fixed jaw of the clamping mechanism is mounted onto one end of the rigid support beam. The support scissoring mechanism is an adjustable support assembly that can be locked in a desired orientation. The mount for electronic devices is capable of being attached to various other pieces of musical equipment or stage equipment because a stand-grasping fastener is affixed to a second end of the support scissor mechanism, opposite to the fixed jaw.

The current application is a continuation-in-part (CIP) application of a U.S. non-provisional application Ser. No. 15/435,107 filed on Feb. 16, 2017. The U.S. non-provisional application Ser. No. 15/435,107 claims a priority to a U.S. provisional application Ser. No. 62/389,023 filed on Feb. 16, 2016.

### FIELD OF THE INVENTION

The present invention relates generally to a music stand. More specifically, the present invention relates to a music stand with an adjustable fastening mechanism that enables the music stand to be attached to the neck of a guitar stand.

### BACKGROUND OF THE INVENTION

Music stands can be made from a multitude of materials and come in various shapes and sizes. Despite these variables, every music stand is designed to accomplish the same task. That is, each music stand is designed to hold sheet music in a position that is easy to read. Despite being designed to serve this one singular purpose, the music stand is often used as a podium during speeches or as a display stand for placards and works of art. While quite useful, one drawback of traditional music stands is that they frequently require the use of a dedicate base. The base must be transported with the music stand. Thus, adding weight to a musician's luggage and reducing mobility. It's often the case that a guitar player will only have the ability to travel with a guitar stand. In such cases the musician must hope that music stands will be provided at any musical engagement.

The present invention, addresses these concerns by providing a music stand that can be mounted onto various pieces of musical equipment including, but not limited to, guitar stands, piano stands, drum stands and microphone stands. To accomplish this, the present invention is a music stand that features an adjustable fastening mechanism can be attached to external devices. The present invention enables the musician to create an ad hoc music stand using any piece of musical or stage equipment. Thus, forgoing the need for a music stand with a dedicated base. In addition to functioning as a music stand, the present invention acts as a support for electronic devices, such as tablet computers, cell phones, and the like. Furthermore, these electronic devices are prevented from falling off the present invention by a clamping mechanism.

### BRIEF DESCRIPTION OF THE DRAWINGS

FIG. 1 is a perspective view of the present invention.

FIG. 2 is a perspective view of the present invention while attached to the neck of a guitar stand.

FIG. 3 is a front view of the present invention.

FIG. 4 is a rear view of the present invention.

FIG. 5 is a left-side view of the present invention.

FIG. 6 is right sectional view of the invention taken along line 6,7-6,7 in FIG. 3 this view shows the spring as a torsion spring.

FIG. 7 is a left-side view of a first alternative embodiment of the present invention taken along line 6,7-6,7 in FIG. 3. This view shows the spring as a compression spring.

FIG. 8 is a front view of the first bracing plate used in the present invention.

FIG. 9 is a front view of the second bracing plate used in the present invention.

FIG. 10 is a perspective view of another embodiment of the present invention with a support scissor mechanism in a forward leaning configuration.

FIG. 11 is a perspective view of the other embodiment of the present invention with the support scissor mechanism in a rearward leaning configuration.

FIG. 12 is a perspective view of the other embodiment of the present invention with a support scissor mechanism in a forward leaning configuration. In this view, the present invention is not attached to the neck of the guitar stand.

FIG. 13 is a perspective view of the other embodiment of the present invention with a support scissor mechanism in a forward leaning configuration. In this view, the clamping mechanism is detached from the support scissor mechanism.

FIG. 14 is a perspective view of the other embodiment of the present invention with a left elongated brace and a right elongated brace.

FIG. 15 is a perspective view of the other embodiment of the present invention with the left elongated brace and the right elongated brace pivoted away from the back panel.

### DETAIL DESCRIPTIONS OF THE INVENTION

All illustrations of the drawings are for the purpose of describing selected versions of the present invention and are not intended to limit the scope of the present invention.

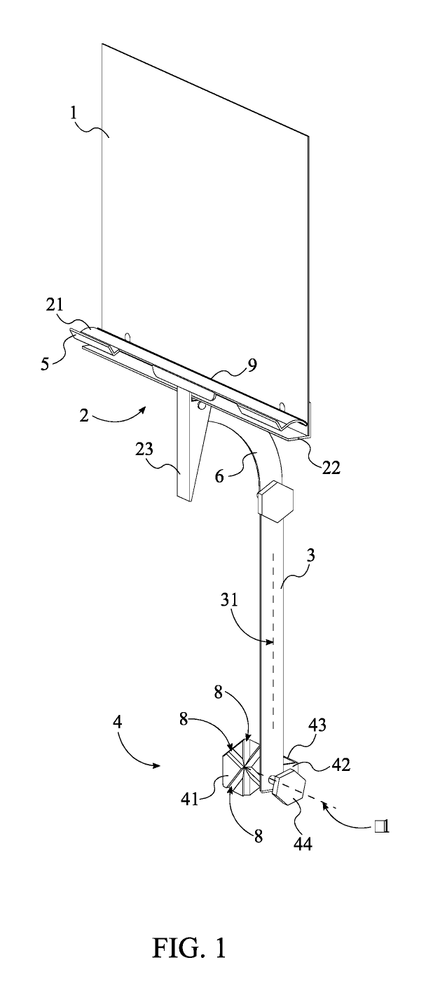

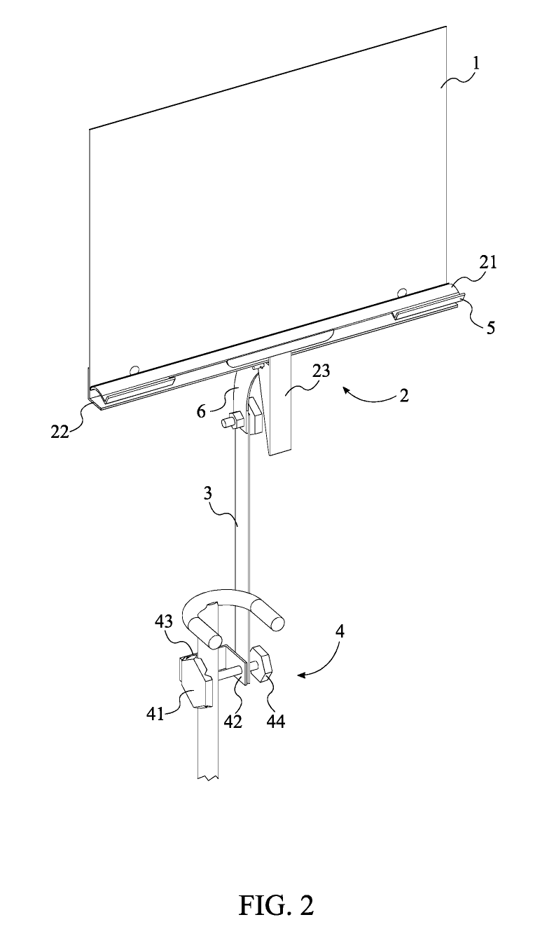

In reference to FIG. 1 and FIG. 2, the present invention, the mount for attaching electronic devices to a guitar stand, enables a user to affix a tablet computer onto a standard guitar stand. The term guitar stand is used herein to refer to items including, but not limited to, music stands, microphone stands, and marching band clips. To accomplish this, the present invention comprises a back panel 1, a clamping mechanism 2, a support beam 3, and a multi-position fastener 4. The back panel 1 is a rigid plate that is used to support the back of a tablet computer. The clamping mechanism 2 is a user operated clamp that retains the inserted tablet computer in a desired position until the clamping mechanism 2 is disengaged. Additionally, the clamping mechanism 2 comprises a movable jaw 21 and a fixed jaw 22. The fixed jaw 22 is a rigid component of the clamping mechanism 2 against which the movable jaw 21 is pressed. Furthermore, the fixed jaw 22 is adjacently connected to the back panel 1 so that the back panel 1 is able to easily support the tablet computer that is placed into the clamping mechanism 2. The movable jaw 21 is a rigid component of the clamping mechanism 2 that is moved by the user and used to press the inserted tablet computer against the fixed jaw 22. To that end, the movable jaw 21 is operatively coupled to the fixed jaw 22, wherein the movable jaw 21 is used to press against the fixed jaw 22. Consequently, the movable jaw 21 and the fixed jaw 22 function as a user-actuated clamp.

The support beam 3 is a rigid bar that holds the clamping mechanism 2 in a position that is offset from the guitar stand to which the present invention is attached. This is possible because the fixed jaw 22 is terminally mounted onto the support beam 3. As a result, the fixed jaw 22 is maintained in a position that facilitates viewing the information displayed on the tablet computer inserted into the clamping mechanism 2. The multi-position fastener 4 is a user-actuated fastener that is used to attach the present invention to a guitar stand. To accomplish this, the multi-position fastener 4 is terminally mounted onto the support beam 3, opposite to the fixed jaw 22. Thus positioned, the used is able to attach the multi-position fastener 4 to the guitar stand in a manner that maintains the fixed jaw 22 in a desired position until the multi-position fastener 4 is detached from the guitar stand.

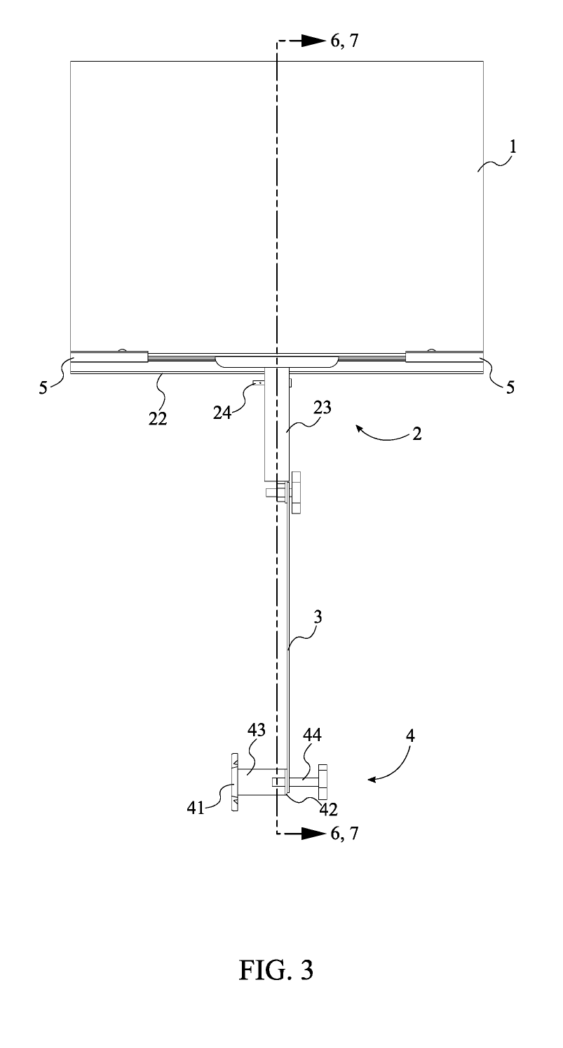

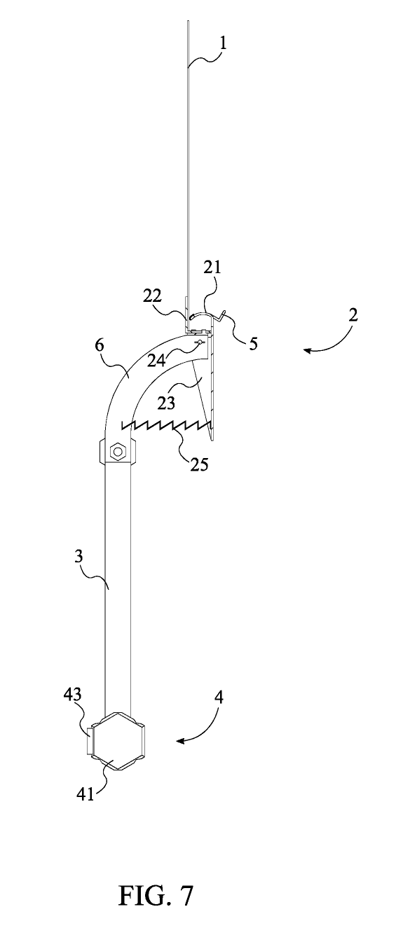

In reference to FIG. 1, FIG. 3, and FIG. 7, expounding upon the descriptions of the clamping mechanism 2, the clamping mechanism 2 further comprises a handle 23, a fulcrum 24, and a spring 25. The handle 23 is a rigid, and ergonomically shaped, component that can be easily grasped by the hand of the user. Additionally, the handle 23 is adjacently connected to the movable jaw 21. Accordingly, motion of the handle 23 is transferred to the movable jaw 21. The fulcrum 24 is a pivot point about which the moving components of the clamping mechanism 2 rotate. To that end, the handle 23 is connected to the fixed jaw 22 by the fulcrum 24 so that the handle 23 is able to pivot about the fulcrum 24 and move the movable jaw 21 closer to or away from the fixed jaw 22.

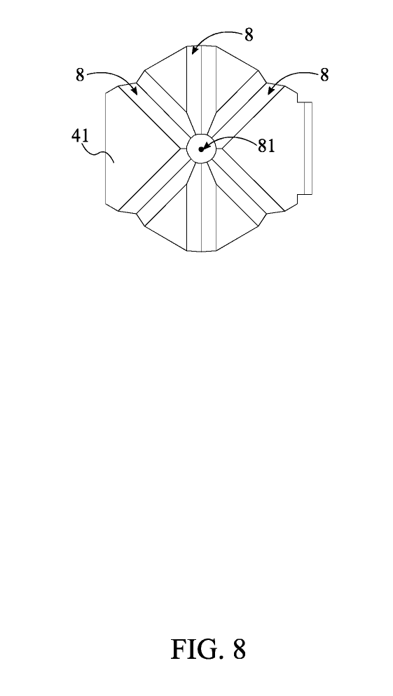

In reference to FIG. 3, FIG. 7, and FIG. 8, the spring 25 is operatively coupled between the movable jaw 21 and the fixed jaw 22, wherein the spring 25 is used to retract the movable jaw 21 toward the fixed jaw 22. Consequently, the spring 25 applies a force to the handle 23 that causes the movable jaw 21 to press against the fixed jaw 22 when no external forces are applied. In the preferred embodiment of the present invention, the spring 25 is a torsion spring 25. In this embodiment, the torsion spring 25 is mechanically integrated into the fulcrum 24, wherein the torsion spring 25 is used to resist rotation of the movable jaw 21 away from the fixed jaw 22. As a result, the torsion spring 25 pivots the handle 23 and the movable jaw 21 toward the fixed jaw 22 about the fulcrum 24. In a first alternative embodiment, the spring 25 is a compression spring 25. In this embodiment, the compression spring 25 is operatively coupled between the handle 23 and the fixed jaw 22, wherein the compression spring 25 is used to resist rotation of the movable jaw 21 away from the fixed jaw 22. Thus positioned, the compression spring 25 becomes compressed when an externally applied force moves the handle 23 and the movable jaw 21 away from the fixed jaw 22. Furthermore, the compression spring 25 expands and moves the handle 23 and the movable jaw 21 toward the fixed jaw 22, once the externally applied force is removed.

In addition to a clamp for electronic devices, the present invention is designed to function as a music stand on which pages of traditional sheet music can be placed. To that end, the present invention further comprises at least one page-stabilizing tab 5. The at least one page-stabilizing tab 5 is a rigid protrusion that extends from the clamping mechanism 2. Furthermore, the at least one page-stabilizing tab 5 is adjacently connected to the movable jaw 21. Accordingly, the at least one page-stabilizing tab 5 is positioned in a location that facilitates supporting sheet music. The at least one page-stabilizing tab 5 is positioned offset from the back panel 1 so that the at least one page-stabilizing tab 5 does not impede the ability of the movable jaw 21 to press against the fixed jaw 22.

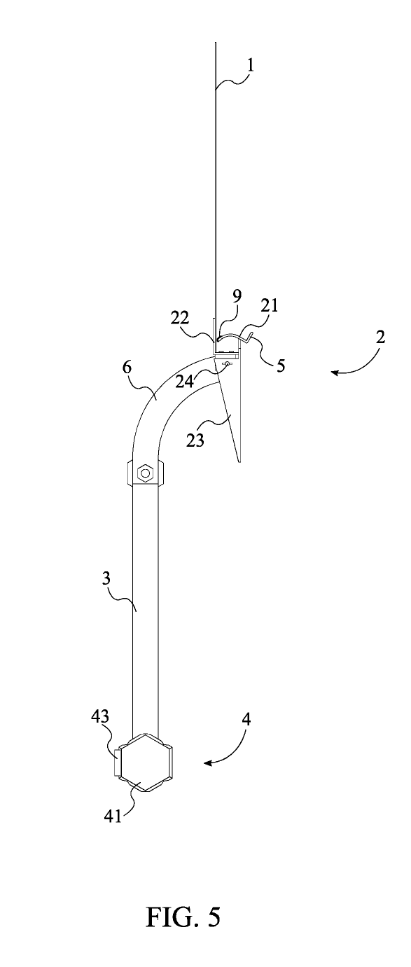

In reference to FIG. 5, the present invention further comprises a neck member 6 that is a rigid bar and used to mount the clamping mechanism 2 onto the support beam 3. The fixed jaw 22 is mounted onto a first end 61 of the neck member 6. As a result, the neck member 6 is able to maintain the clamping mechanism 2 and the back panel 1 in a desired position. Opposite fixed jaw 22, the support beam 3 is pivotably attached to a second end 62 of the neck member 6. Thus attached, the support beam 3 enables the user to adjust the orientation of the neck member 6. In the preferred embodiment of the present invention, the neck member 6 is a curved beam; thus shaped, to maintain the clamping mechanism 2 over the centerline of the attached guitar stand whenever a longitudinal axis 31 of the support beam 3 is parallel to a longitudinal axis of the attached guitar stand. Additionally, the fixed jaw 22 is tangentially connected to the neck member 6 so that the clamping mechanism 2 maintains the back panel 1 in an orientation facilitating viewing on the attached tablet computer. In a second alternative embodiment, the fixed jaw 22 is pivotably connected to the neck member 6. Consequently, the user is able to further adjust the orientation of the clamping mechanism 2 and back panel 1.

In reference to FIG. 1 and FIG. 2, to attach the present invention to a guitar stand, the user makes use of the multi-position fastener 4, which is preferably a user-actuated clamp. To that end, the multi-position fastener 4 comprises a first bracing plate 41, an extension web 43, a second bracing plate 42, a clamping rod 44, and a rod hole 45. The first bracing plate 41 is a rigid panel that is used to brace against the attached guitar stand. The first bracing plate 41 is adjacently connected to the extension web 43. As a result, the extension web 43, which is a rigid beam, is used to connect the first bracing plate 41 to the second bracing plate 42. The second bracing plate 42 is a is a rigid panel that is adjacently connected to the extension web 43, opposite to the first bracing plate 41. Thus positioned, the second bracing plate 42 is used to hold the clamping rod 44 in a position which facilitates bracing the attached guitar stand against the first bracing plate 41. The rod hole 45 traverses through the second bracing plate 42, toward the first bracing plate 41. Accordingly, the clamping rod 44, which engages the rod hole 45, is able to brace the attached guitar stand against the first bracing plate 41.

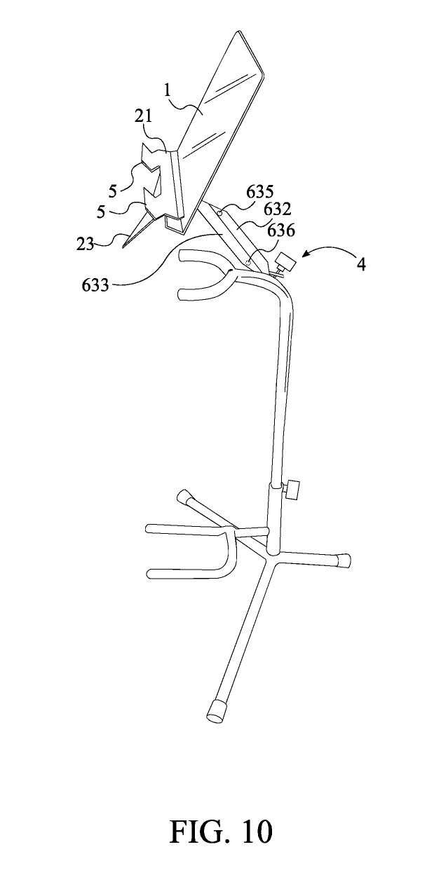

In reference to FIG. 1 and FIG. 10, in the present invention, the support beam 3 is adjacently connected to the second bracing plate 42, opposite to the first bracing plate 41. As a result, the orientation of the support beam 3 relative to the attached guitar stand is adjusted by adjusting the orientation of the multi-position fastener 4. Additionally, the rod hole 45 traverses through the support beam 3. Accordingly, the clamping rod 44 may move through the rod hole 45 unimpeded. In a third alternative embodiment, the present invention comprises a locking mechanism 7. Additionally, the support beam 3 is pivotably connected to the second bracing plate 42, opposite to the first bracing plate 41. Similarly, the rod hole 45 traverses through the support beam 3 so that the clamping rod 44 forms an axis about which the support beam 3 and the second bracing plate 42 rotate. The locking mechanism 7 is a user-activated device that prevents the second bracing plate 42 and the support arm from rotating about the clamping rod 44. To that end, the locking mechanism 7 is integrated into the pivoting connection between the support beam 3 and the second bracing plate 42. Consequently, the locking mechanism 7 does not impede the rotation of the support beam 3 or the while disengaged. In a fourth alternative embodiment, the multi-position fastener is a rod that can be inserted into the neck of a guitar stand. In this embodiment, the multi-position fastener can be held in a desired position by a lock pin. In a fifth alternative embodiment, a guitar yolk is attached to the multi-position fastener. This enables the present invention to be used as a guitar rest in addition to a music stand.

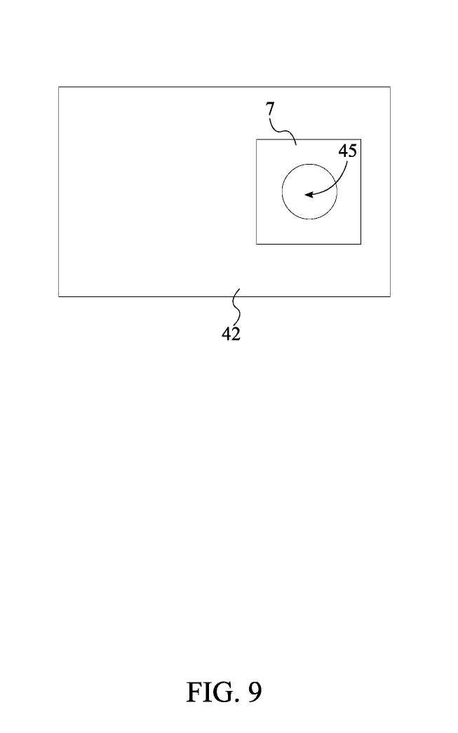

In reference to FIG. 1 and FIG. 9, to facilitate maintaining the support beam 3 and locking mechanism 7 in a desired orientation, the present invention, comprises a plurality of position-orienting grooves 8. The plurality of position-orienting grooves 8 traverses into the first bracing plate 41. As a result, each groove in the plurality of position-orienting grooves 8 is able to function as a cradle for a lateral surface for the attached guitar stand. Additionally, each of the plurality of position-orienting grooves 8 is radially distributed about a central axis 81. Thus positioned, each groove is able to hold the multi-position fastener 4 at a separate orientation relative to the longitudinal axis of the attached guitar stand. Furthermore, a first position-orienting groove is aligned with a longitudinal axis 31 of the support beam 3 so that the multi-position fastener 4 is able to maintain the longitudinal axis 31 of the support beam 3 in a parallel orientation relative to the longitudinal axis of the attached guitar stand.

In reference to FIG. 1 and FIG. 10, in the present invention, the rod hole 45 is preferably a female -threaded hole and the clamping rod 44 is a male-threaded bolt. Additionally, the male threaded bolt engages the female threaded hole. Consequently, the user is able to move the clamping rod 44 through the rod hole 45 by rotating the clamping rod 44.

In reference to FIG. 1, the present invention further comprises at least one cushioned grip 9. The at least one cushioned grip 9 is a texturized material that is used to maintain the inserted tablet computer within the clamping mechanism 2 without damaging the inserted tablet computer. The at least one cushioned grip 9 is connected adjacent to the movable jaw 21. As a result, the at least one cushioned grip 9 prevents the movable jaw 21 from coming into contact with the fixed jaw 22. Furthermore, the at least one cushioned grip 9 is oriented toward the fixed jaw 22 to facilitate protecting the screen of the inserted tablet computer.

### Description of Another Embodiment:

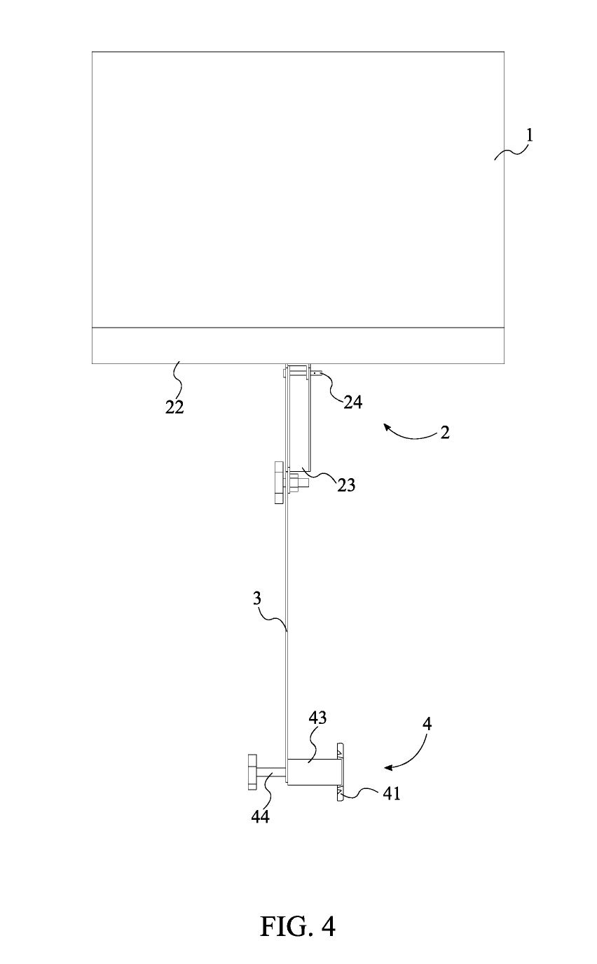

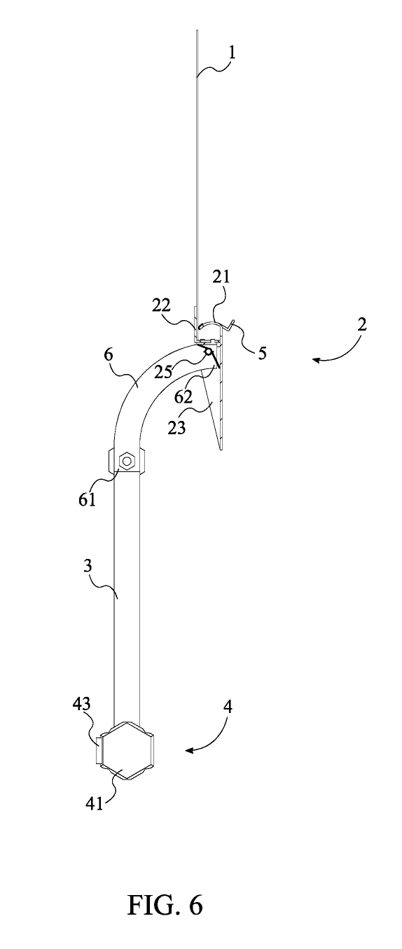

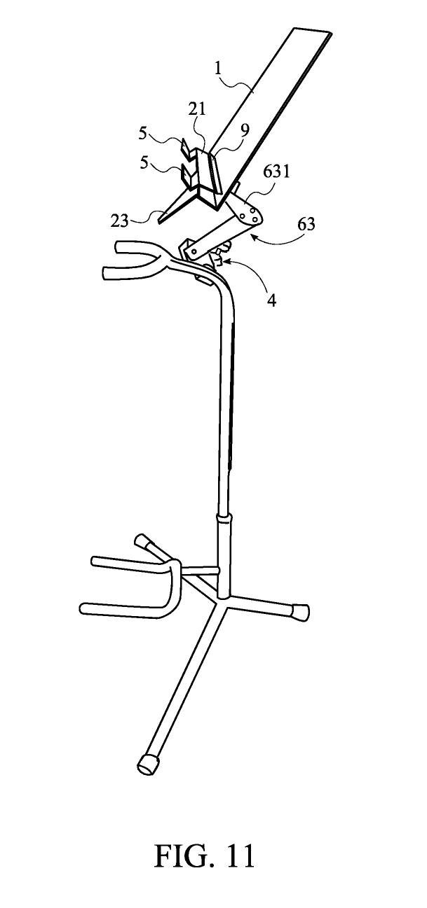

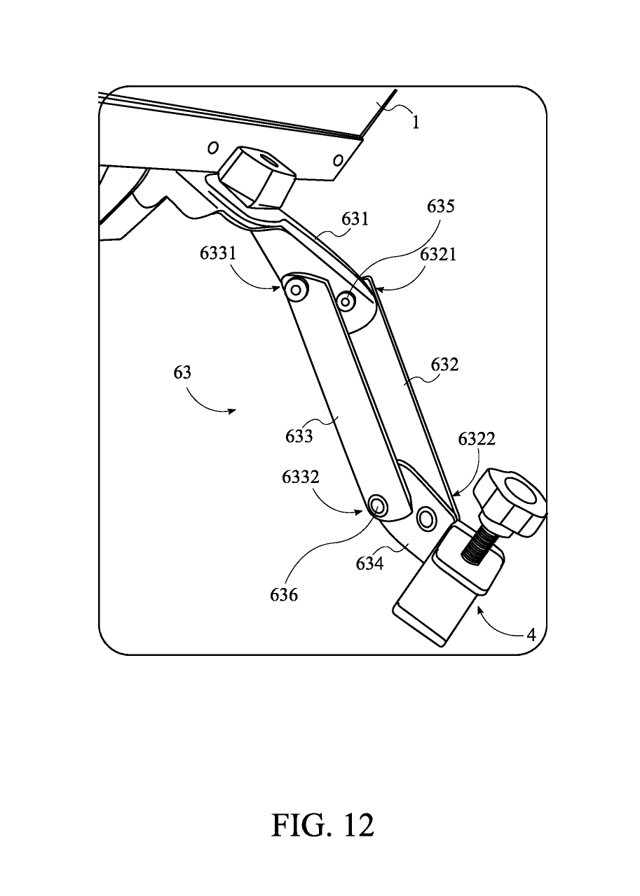

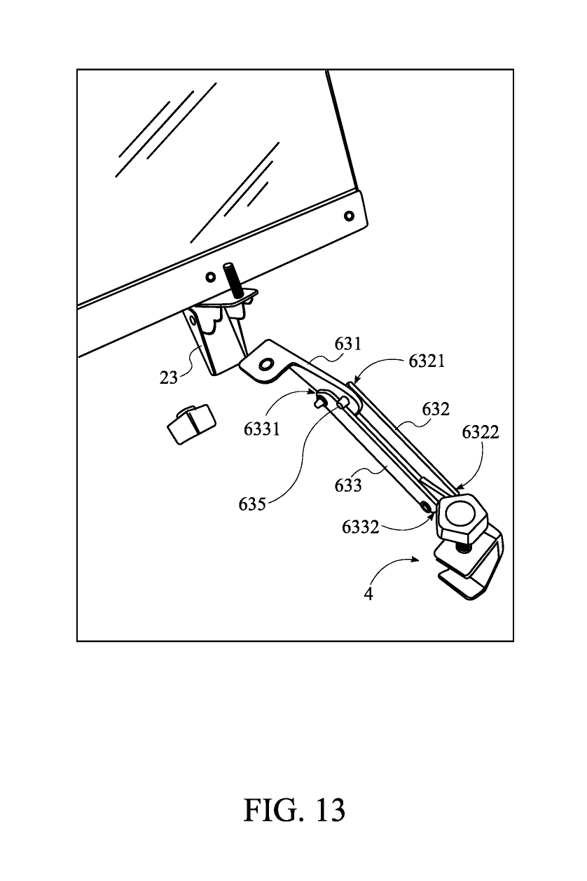

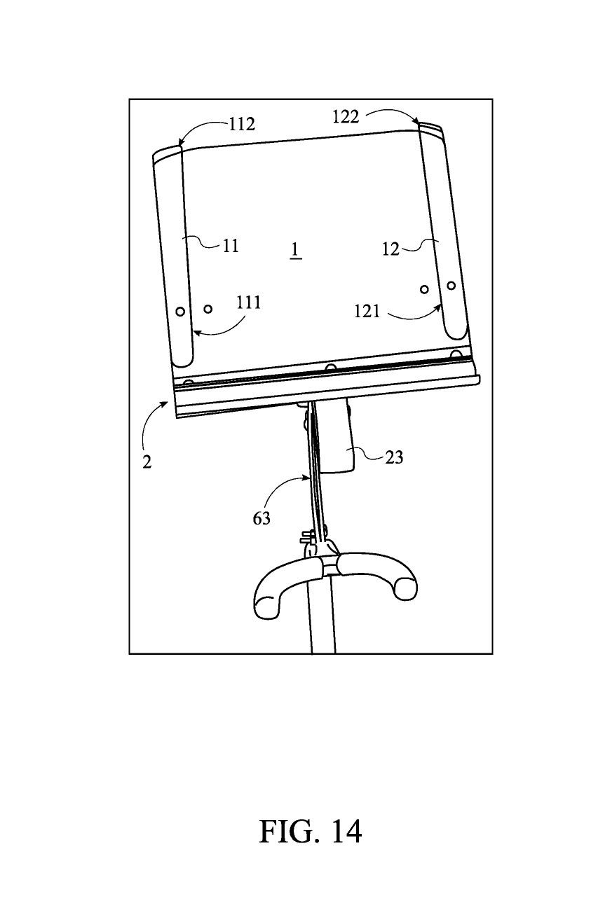

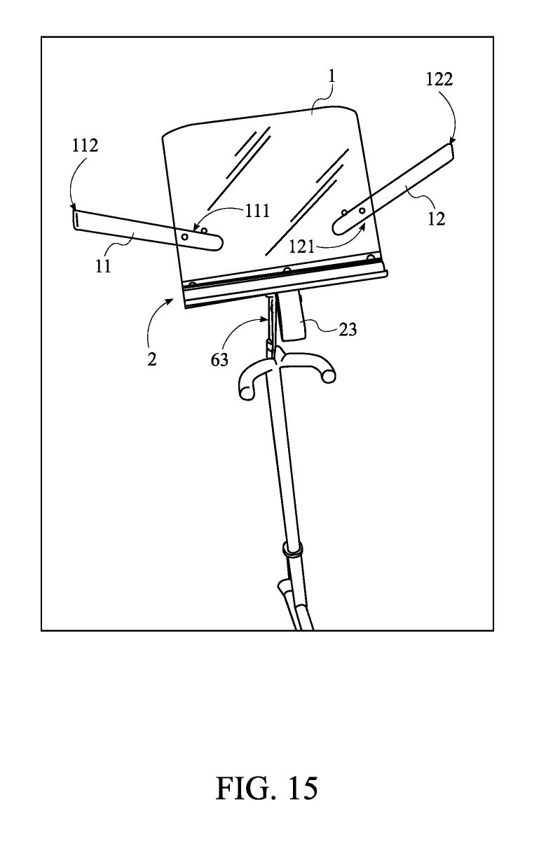

In reference to FIG. 1 through FIG. 15, another embodiment of the present invention enables a user to affix a tablet computer onto a standard guitar stand. This other embodiment of the present invention comprises a back panel 1, a clamping mechanism 2, a support scissor mechanism 63, and a stand-grasping fastener 4. The back panel 1 is a rigid plate that is used to support the back of a tablet computer. The clamping mechanism 2 is a user operated clamp that retains the inserted tablet computer in a desired position until the clamping mechanism 2 is disengaged. Additionally, the clamping mechanism 2 comprises a movable jaw 21 and a fixed jaw 22. The fixed jaw 22 is a rigid component of the clamping mechanism 2 against which the movable jaw 21 is pressed. Furthermore, the fixed jaw 22 is adjacently connected to the back panel 1 so that the back panel 1 is able to easily support the tablet computer that is placed into the clamping mechanism 2. The movable jaw 21 is a rigid component of the clamping mechanism 2 that is moved by the user and used to press the inserted tablet computer against the fixed jaw 22. To that end, the movable jaw 21 is operatively coupled to the fixed jaw 22, wherein the movable jaw 21 is used to press against the fixed jaw 22. Consequently, the movable jaw 21 and the fixed jaw 22 function as a user-actuated clamp.

The support scissor mechanism 63 is a mechanically extendable-or-retractable structure that is used to selectively move the back panel 1 towards or away from a guitar stand, to which this embodiment of the present invention is attached. Thus, the clamping mechanism 2 is in a position that is offset from the guitar stand. This is possible because the fixed jaw 22 is terminally mounted onto the support scissor mechanism 63. As a result, the fixed jaw 22 is maintained in a position that facilitates viewing the information displayed on the tablet computer inserted into the clamping mechanism 2. In addition, the support scissor mechanism 63 is typically an elongated object that allows the user to shift the center of gravity away from the guitar stand so that the combined apparatus of the present invention and the guitar stand are able to stay upright and maintain its balance. The stand-grasping fastener 4 is a user-actuated fastener that is used to attach the present invention to a guitar stand. To accomplish this, the stand-grasping fastener 4 is terminally mounted onto the support scissor mechanism 63, opposite to the fixed jaw 22. Thus positioned, the user is able to attach the stand-grasping fastener 4 to the guitar stand in a manner that maintains the fixed jaw 22 in a desired position until the stand-grasping fastener 4 is detached from the guitar stand.

Expounding upon the descriptions of the clamping mechanism 2, the clamping mechanism 2 further comprises a handle 23, a fulcrum 24, and a spring 25. The handle 23 is a rigid, and ergonomically shaped, component that can be easily grasped by the hand of the user. Additionally, the handle 23 is adjacently connected to the movable jaw 21. Accordingly, motion of the handle 23 is transferred to the movable jaw 21. The fulcrum 24 is a pivot point about which the moving components of the clamping mechanism 2 rotate. To that end, the handle 23 is connected to the fixed jaw 22 by the fulcrum 24 so that the handle 23 is able to pivot about the fulcrum 24 and move the movable jaw 21 closer to or away from the fixed jaw 22.

The spring 25 is operatively coupled between the movable jaw 21 and the fixed jaw 22, wherein the spring 25 is used to retract the movable jaw 21 toward the fixed jaw 22. Consequently, the spring 25 applies a force to the handle 23 that causes the movable jaw 21 to press against the fixed jaw 22 when no external forces are applied. In the preferred embodiment of the present invention, the spring 25 is a torsion spring 25. In this embodiment, the torsion spring 25 is mechanically integrated into the fulcrum 24, wherein the torsion spring 25 is used to resist rotation of the movable jaw 21 away from the fixed jaw 22. As a result, the torsion spring 25 pivots the handle 23 and the movable jaw 21 toward the fixed jaw 22 about the fulcrum 24. In a first alternative embodiment, the spring 25 is a compression spring 25. In this embodiment, the compression spring 25 is operatively coupled between the handle 23 and the fixed jaw 22, wherein the compression spring 25 is used to resist rotation of the movable jaw 21 away from the fixed jaw 22. Thus positioned, the compression spring 25 becomes compressed when an externally applied force moves the handle 23 and the movable jaw 21 away from the fixed jaw 22. Furthermore, the compression spring 25 expands and moves the handle 23 and the movable jaw 21 toward the fixed jaw 22, once the externally applied force is removed.

In addition to a clamp for electronic devices, the present invention is designed to function as a music stand on which pages of traditional sheet music can be placed. To that end, the present invention further comprises at least one page-stabilizing tab 5. The at least one page-stabilizing tab 5 is a rigid protrusion that extends from the clamping mechanism 2. Furthermore, the at least one page-stabilizing tab 5 is adjacently connected to the movable jaw 21. Accordingly, the at least one page-stabilizing tab 5 is positioned in a location that facilitates supporting sheet music. The at least one page-stabilizing tab 5 is positioned offset from the back panel 1 so that the at least one page-stabilizing tab 5 does not impede the ability of the movable jaw 21 to press against the fixed jaw 22.

To attach the present invention to a guitar stand, the user makes use of the stand-grasping fastener 4, which is preferably a user-actuated clamp. To that end, the stand-grasping fastener 4 can be a C-clamp. Alternatively, the stand-grasping fastener 4 can comprise a first bracing plate 41, an extension web 43, a second bracing plate 42, a clamping rod 44, and a rod hole 45. The first bracing plate 41 is a rigid panel that is used to brace against the attached guitar stand. The first bracing plate 41 is adjacently connected to the extension web 43. As a result, the extension web 43, which is a rigid beam, is used to connect the first bracing plate 41 to the second bracing plate 42. The second bracing plate 42 is a rigid panel that is adjacently connected to the extension web 43, opposite to the first bracing plate 41. Thus positioned, the second bracing plate 42 is used to hold the clamping rod 44 in a position which facilitates bracing the attached guitar stand against the first bracing plate 41. The rod hole 45 traverses through the second bracing plate 42, toward the first bracing plate 41. Accordingly, the clamping rod 44, which engages the rod hole 45, is able to brace the attached guitar stand against the first bracing plate 41.

In this other embodiment of the present invention, the support scissor mechanism 63 is adjacently connected to the second bracing plate 42, opposite to the first bracing plate 41. As a result, the orientation of the support scissor mechanism 63 relative to the attached guitar stand is adjusted by adjusting the orientation of the strand-grasping fastener 4. Additionally, the rod hole 45 traverses through the support scissor mechanism 63. Accordingly, the clamping rod 44 may move through the rod hole 45 unimpeded. In a third alternative embodiment, the present invention comprises a locking mechanism 7. Additionally, the support scissor mechanism 63 is pivotably connected to the second bracing plate 42, opposite to the first bracing plate 41. Similarly, the rod hole 45 traverses through the support scissor mechanism 63 so that the clamping rod 44 forms an axis about which the support scissor mechanism 63 and the second bracing plate 42 rotate. The locking mechanism 7 is a user-activated device that prevents the second bracing plate 42 and the support scissor mechanism 63 from rotating about the clamping rod 44. To that end, the locking mechanism 7 is integrated into the pivoting connection between the support scissor mechanism 63 and the second bracing plate 42. Consequently, the locking mechanism 7 does not impede the rotation of the support scissor mechanism 63 or the second bracing plate 42 while disengaged. In a fourth alternative embodiment, the stand-grasping fastener 4 is a rod that can be inserted into the neck of a guitar stand. In this embodiment, the stand-grasping fastener 4 can be held in a desired position by a lock pin. In a fifth alternative embodiment, a guitar yolk is attached to the stand-grasping fastener 4. This enables the present invention to be used as a guitar rest in addition to a music stand.

To facilitate maintaining the support scissor mechanism 63 and locking mechanism 7 in a desired orientation, the present invention, comprises a plurality of position-orienting grooves 8. The plurality of position-orienting grooves 8 traverses into the first bracing plate 41. As a result, each groove in the plurality of position-orienting grooves 8 is able to function as a cradle for a lateral surface for the attached guitar stand. Additionally, each of the plurality of position-orienting grooves 8 is radially distributed about a central axis 81. Thus positioned, each groove is able to hold the stand-grasping fastener 4 at a separate orientation relative to the longitudinal axis of the attached guitar stand. Furthermore, a first position-orienting groove is aligned with a longitudinal axis of the support scissor mechanism 63 so that the stand-grasping fastener 4 is able to maintain the longitudinal axis of the support scissor mechanism 63 in a parallel orientation relative to the longitudinal axis of the attached guitar stand.

In the present invention, the rod hole 45 is preferably a female-threaded hole and the clamping rod 44 is a male-threaded bolt. Additionally, the male threaded bolt engages the female threaded hole. Consequently, the user is able to move the clamping rod 44 through the rod hole 45 by rotating the clamping rod 44.

This other embodiment of the present invention further comprises at least one cushioned grip 9. The at least one cushioned grip 9 is a texturized material that is used to maintain the inserted tablet computer within the clamping mechanism 2 without damaging the inserted tablet computer. The at least one cushioned grip 9 is connected adjacent to the movable jaw 21. As a result, the at least one cushioned grip 9 prevents the movable jaw 21 from coming into contact with the fixed jaw 22. Furthermore, the at least one cushioned grip 9 is oriented toward the fixed jaw 22 to facilitate protecting the screen of the inserted tablet computer.

The support scissor mechanism 63 is used to keep the back panel 1 in an upright positioning while allowing the present invention to shift its center of gravity away from the guitar stand that the present invention is attached to. The support scissor mechanism 63 comprises a forward base panel 631, an upper scissor leg 632, a lower scissor leg 633, and a rear base panel 634. The upper scissor leg 632 is a movable structural piece, which comprises a first upper end 6321 and a second upper end 6322. Similarly, the lower scissor leg 633 is another movable structural piece, which comprises a first lower end 6331 and a second lower end 6332. The forward base panel 631 is a fixed structural piece, which is mounted to the clamping mechanism 2. Moreover, the rear base panel 634 is a fixed structural piece, which is mounted to the stand-grasping fastener 4. In order to facilitate movement between the clamping mechanism 2 and the support scissor mechanism 63, the first upper end 6321 and the second upper end 6322 are pivotably connected onto the forward base panel 631 and are positioned offset from each other across the forward base panel 631. In order to facilitate movement between the support scissor mechanism 63 and the stand-grasping fastener 4, the first lower end 6331 and the second lower end 6332 are pivotably connected onto the rear base panel 634 and are positioned offset from each other across the rear base panel 634. In addition, the forward base panel 631 and the rear base panel 634 are positioned in between the upper scissor leg 632 and the lower scissor leg 633, which allows the forward base panel 631 and the rear base panel 634 to guide the extending movement or the retracting movement of the support scissor mechanism 63.

In order to prevent the support scissor mechanism 63 from extending or retracting too far, the support scissor mechanism 63 further comprises an upper leg stop 635 and a lower leg stop 636. The upper leg stop 635 is used to laterally press against the upper scissor leg 632, if the upper scissor leg 632 moves too far forward. The upper leg stop 635 is connected onto the rear base panel 634, opposite the second lower end 6332, and is laterally positioned offset from the upper scissor leg 632 so that the upper leg stop 635 is able to readily impede the movement of the upper scissor leg 632. Likewise, the lower leg stop 636 is used to laterally press against the lower scissor leg 633, if the lower scissor leg 633 moves too far forward. The lower leg stop 636 is connected onto the forward base panel 631, opposite the first upper end 6321, and is laterally positioned offset from the lower scissor leg 633 so that the lower leg stop 636 is able to readily impede the movement of the lower scissor leg 633.

This other embodiment of the present invention comprises a left elongated brace 11 and a right elongated brace 12, which are used to extend the usable width of the present invention to brace a book or some other wide object. The left elongated brace 11 comprises a left fixed end 111 and a left free end 112. In a horizontal orientation, the left elongated brace 11 allows the present invention to support the left extremity of an object resting on the back panel 1. In a vertical orientation, the left elongated brace 11 allows the present invention to further press the object against the back panel 1. Thus, the left fixed end 111 is pivotably connected onto the back panel 1, opposite the fixed jaw 22, so that the left elongated brace 11 is able to readily rotate from the vertical orientation to the horizontal orientation and vice versa. Similarly, the right elongated brace 12 comprises a right fixed end 121 and a right free end 122. In a horizontal orientation, the right elongated brace 12 allows the present invention to support the right extremity of an object resting on the back panel 1. In a vertical orientation, the right elongated brace 12 allows the present invention to further press the object against the back panel 1. Thus, the right fixed end 121 is pivotably connected onto the back panel 1, opposite the fixed jaw 22, so that the right elongated brace 12 is able to readily rotate from the vertical orientation to the horizontal orientation and vice versa. Moreover, the left fixed end 111 and the right fixed end 121 are positioned opposite to each other, and the scissor support mechanism is positioned in between the left fixed end 111 and the right fixed end 121. This arrangement of the left fixed end 111 and the right fixed end 121 allow the present invention to properly brace the object resting on the back panel 1 from its left extremity to its right extremity.

The present invention further comprises a left page-pressing hook 13 and a right page-pressing hook 14, which are used to hold an object resting on the back panel 1 in place, while the left elongated brace 11 and the right elongated brace 12 are in the vertical orientation. The left page-pressing hook 13 is connected onto the left free end 112 and is oriented towards the back panel 1 so that the left page-pressing hook 13 is able to hold the top of the object in place. Likewise, the right page-pressing hook 14 is connected onto the right free end 122 and is oriented towards the back panel 1 so that the right page-pressing hook 14 is able to hold the top of the object in place.

### Alternate Description for the Other Embodiment:

The present invention relates generally to a stand. More specifically, the present invention is a clip-on stand for holding all forms of music that can be attached to other stands.

The present invention is designed to enable the user to read all types of sheet music from a guitar stand, eliminating the need for a separate music stand or I-pod stand. The present invention makes the guitar stand versatile, and keeps music, stand and guitar in one place for use or storage in a smaller space.

The advantages include, but are not limited to: the present invention is simple and easy to install on guitar stands; the present invention makes the guitar stand convenient storage for music, guitar and music stand all in one place; easily movable from place to place; the present invention reduces the amount of gear for professionals to carry; the present invention reduces the amount of space required for music stand and guitar stand; and the present invention holds all types of sheet music securely.

The present invention is a desk for holding all forms music that attaches to a guitar stand, or other stands. A bottom clip across the bottom of the present invention holds electronic devices, books, or single sheets securely. Tabs on the clip allows music to be held as a conventional music stand in addition to keeping pages from inadvertently turning. Pages in this mode can be easily turned manually. The present invention is supported by a two-member support arm that distributes weight forward to the center of gravity in front of the guitar stand for stability. The upright member is connected by a knob or thumb screw and clamp which allows the angle of the present invention to be adjusted to the desired position. The present invention's arm can be folded along the side of the desk portion to facilitate carrying or storage. The supporting arm can be removed for shipping by taking out a single thumb screw.

One specific feature is that the design has a reading position forward to the center of gravity to the front of the guitar stand to increase stability. In this position, the guitar cannot be placed in the guitar stand. The present invention can be pivoted to the back of the guitar stand, in storage mode, to receive a guitar for storage.

Another specific feature is that the bottom clip of the present invention holds music, electronic devices, or pages in place eliminating the need for conventional wire hold-downs.

Another specific feature is that the bottom clip has a rubber edge to protect electronic devices and keep them from sliding from side to side.

Another specific feature is that the bottom clip holds work securely which makes it possible to use a smaller back support for music reducing the overall weight of the present invention.

Another specific feature is that tabs on the bottom clip hold music pages in place if the bottom clip mode is not used. The user may elect not to use the bottom clip if frequent page turning is desired.

Another specific feature is that the present invention is attached to the top of the guitar stand adjacent to the yoke that holds the guitar neck.

Another specific feature is that the orientation of the thumb screw on the present invention's clamp is such that it protrudes upward on top of the guitar stand support member.

Although the invention has been explained in relation to its preferred embodiment, it is to be understood that many other possible modifications and variations can be made without departing from the spirit and scope of the invention as hereinafter claimed.

1. A mount for attaching electronic devices to a guitar stand comprising:
a back panel;
a clamping mechanism;
a support scissor mechanism;
a stand-grasping fastener;
the clamping mechanism comprising a movable jaw and a fixed jaw;
the fixed jaw being adjacently connected to the back panel;
the movable jaw being operatively coupled to the fixed jaw;
the movable jaw being used to press against the fixed jaw;
the fixed jaw being terminally mounted onto the support scissor mechanism;
the stand-grasping fastener being terminally mounted onto the support scissor mechanism, opposite to the fixed jaw;

2. The mount for attaching electronic devices to a guitar stand as claimed in claim 1 comprising:
the clamping mechanism comprising a handle, a fulcrum, and a spring;
the handle being adjacently connected to the movable jaw;
the handle being hingedly connected to the fixed jaw by the fulcrum; and
the spring being operatively coupled between the movable jaw and the fixed jaw, wherein the spring is used to retract the movable jaw toward the fixed jaw.

3. The mount for attaching electronic devices to a guitar stand as claimed in claim 2 comprising:
the spring being a torsion spring; and
the torsion spring being mechanically connected with the fulcrum, wherein the torsion spring is used to resist rotation of the movable jaw away from the fixed jaw.

4. The mount for attaching electronic devices to a guitar stand as claimed in claim 2 comprising:
the spring being a compression spring; and
the compression spring being operatively coupled between the handle and the fixed jaw, wherein the compression spring is used to resist rotation of the movable jaw away from the fixed jaw.

5. The mount for attaching electronic devices to a guitar stand as claimed in claim 1 comprising:
at least one page-stabilizing tab;
the at least one page-stabilizing tab being adjacently connected to the movable jaw; and
the at least one page-stabilizing tab being positioned offset from the back panel.

6. The mount for attaching electronic devices to a guitar stand as claimed in claim 1 comprising:
the stand-grasping fastener comprising a first bracing plate, an extension web, a second bracing plate and a clamping rod;
the first bracing plate being adjacently connected to the extension web;
the second bracing plate being adjacently connected to the extension web, opposite to the first bracing plate;
the second bracing plate comprising a first through hole traversing therethrough, toward the first bracing plate; and
the clamping rod engaging the first through hole.

7. The mount for attaching electronic devices to a guitar stand as claimed in claim 6 comprising:
the support scissor mechanism being adjacently connected to the second bracing plate, opposite to the first bracing plate;
the support scissor mechanism comprising a second through hole traversing therethrough; and
the first through hole and the second through hole corresponding to each other.

8. The mount for attaching electronic devices to a guitar stand as claimed in claim 6 comprising:
a locking mechanism;
the support scissor mechanism being pivotably connected to the second bracing plate, opposite to the first bracing plate;
the support scissor mechanism comprising a second through hole traversing therethrough;
the first through hole and the second through hole corresponding to each other; and
the locking mechanism being integrated into the pivoting connection between the support scissor mechanism and the second bracing plate.

9. The mount for attaching electronic devices to a guitar stand as claimed in claim 6 comprising:
a plurality of position-orienting grooves;
the plurality of position-orienting grooves traversing into the first bracing plate;
each of the position-orienting grooves being radially distributed about a center of the first bracing plate; and
a first position-orienting groove being aligned with a longitudinal axis of the support scissor mechanism.

10. The mount for attaching electronic devices to a guitar stand as claimed in claim 6 comprising:
the first through hole being a female threaded hole;
the clamping rod being a male threaded bolt; and
the male threaded bolt engaging into the female threaded hole.

11. The mount for attaching electronic devices to a guitar stand as claimed in claim 1 comprising:
at least one cushioned grip;
the at least one cushioned grip being connected adjacent to the movable jaw; and
the at least one cushioned grip being oriented toward the fixed jaw.

12. The mount for attaching electronic devices to a guitar stand as claimed in claim 1 comprising:
the support scissor mechanism comprises a forward base panel, an upper scissor leg, a lower scissor leg, and a rear base panel;
the upper scissor leg comprises a first upper end and a second upper end;
the lower scissor leg comprises a first lower end and a second lower end;
the first upper end and the second upper end being pivotably connected onto the forward base panel;
the first upper end and the second upper end being positioned offset from each other across the forward base panel;
the first lower end and the second lower end being pivotably connected onto the rear base panel;
the first lower end and the second lower end being positioned offset from each other across the rear base panel;
the forward base panel and the rear base panel being positioned in between the upper scissor leg and the lower scissor leg;

13. The mount for attaching electronic devices to a guitar stand as claimed in claim 12 comprising:
the support scissor mechanism further comprises an upper leg stop;
the upper leg stop being connected onto the rear base panel, opposite the second lower end; and
the upper leg stop being laterally positioned offset from the upper scissor leg.

14. The mount for attaching electronic devices to a guitar stand as claimed in claim 12 comprising:
the support scissor mechanism further comprises a lower leg stop;
the lower leg stop being connected onto the forward base panel, opposite the first upper end; and
the lower leg stop being laterally positioned offset from the lower scissor leg.

15. The mount for attaching electronic devices to a guitar stand as claimed in claim 1 comprising:
a left elongated brace;
a right elongated brace;
the left elongated brace comprises a left fixed end and a left free end;
the right elongated brace comprises a right fixed end and a right free end;
the left fixed end being pivotably connected onto the back panel, opposite the fixed jaw;
the right fixed end being pivotably connected onto the back panel, opposite the fixed jaw;
the left fixed end the right fixed end being positioned opposite to each other across the back panel; and
the scissor support mechanism being positioned in between the left fixed end and the right fixed end.

16. The mount for attaching electronic devices to a guitar stand as claimed in claim 15 comprising:
a left page-pressing hook;
a right page-pressing hook;
the left page-pressing hook being connected onto the left end;
the left page-pressing hook being oriented towards the back panel;
the right page-pressing hook being connected onto the right end; and
the right page-pressing hook being oriented towards the back panel.
